(19) United States
(12) Patent Application Publication
(10) Pub. No.: US 2021/0229136 A1
(43) Pub. Date: Jul. 29, 2021

(54) ION SOURCES WITH IMPROVED CLEANING BY ABLATING LIGHT

(71) Applicant: ASCEND DIAGNOSTICS LIMITED, Greater Manchester (GB)

(72) Inventors: John Mark ALLISON, Greater Manchester (GB); Diana Vladimirovna KALININA, Greater Manchester (GB)

(21) Appl. No.: 15/734,580

(22) PCT Filed: Jun. 14, 2019
(86) PCT No.: PCT/GB2019/051655

§ 371 Date: Dec. 3, 2020

(30) Foreign Application Priority Data
Jun. 15, 2018 (GB) 1809901.0

(51) Int. Cl. B08B 7/00; H01J 49/16

(52) U.S. Cl. CPC B08B 7/0042; H01J 49/164

(57) ABSTRACT

An ion source comprises an ionising light source arranged to output ionising light for ionising a sample material, an electrode presenting an electrode surface for attracting the ionised sample material and upon which contaminant material is able to accumulate, and an ablating light source arranged to output an ablating light beam or pulse(s) for ablating material of the electrode from the electrode surface. The ablating light beam or pulse(s) does not include said ionising light. A reflector for reflecting the ablating light onto the electrode surface, therewith by a process of ablation a part of the electrode surface is removable from the electrode together with contaminant material when accumulated upon that part.

### FIELD

The invention relates to ion sources for mass spectrometers. In particular, though not exclusively, the invention relates to ion sources for mass spectrometers configured to implement matrix-assisted laser desorption/ionization (MALDI), and mass spectrometers such as mass spectrometers comprising MALDI ion sources. The invention also relates to methods and apparatus for cleaning such mass spectrometers or ion sources.

### BACKGROUND

Mass spectrometers require ion sources for the preparation and provision of a beam of ions of an analyte material for mass-spectrometric analysis. The process of ion beam provision can involve a process of generating a plume of material containing ions of the analyte, which are subsequently formed into an ion beam using electric and/or magnetic fields. However, the plume in question often contains material other than the analyte. This extraneous material is considered to be a contaminant material as it can often accumulate upon internal surfaces of an ion source apparatus, which is highly undesirable. This is particularly, though not exclusively, a problem in mass spectrometer ion sources implementing a MALDI process.

Matrix-assisted laser desorption/ionisation (MALDI) is an ion generation technique whereby pulses of laser light, such as ultraviolet (UV) laser light, are focused onto a material consisting of a matrix material which encapsulates a quantity of analyte material within it. The matrix material is selected to be efficient at absorbing the light of the laser so that it efficiently desorbs from the body of the matrix when struck by the laser light thereby to release the encapsulated analyte material which is ionised in the process. The released ions of analyte material may be formed into an ion beam using appropriate ion optics of the ion source, whereas desorbed matrix material constitutes a contaminant.

Prior art document GB2486628B proposes a method of cleaning contaminant material from surfaces within an ion source by desorption of contaminant material using ultraviolet (UV) laser light. In particular, this method uses the same UV light for the desorption of contaminant material as is also employed in the MALDI process itself. This choice of UV light for cleaning purposes is driven by the need for efficient absorption of that light by the contaminant material, thereby enabling desorption of the material from a contaminated surface. There are many disadvantages in using ultraviolet (UV) light for cleaning contaminant material in this way. Some of these disadvantages are related to the higher photon energy associated with UV light. It is well known that UV laser light degrades optical components, especially where the components in question are close to a laser focal point and therefore subject to high laser intensities. For example, a mirror used in the method described in GB2486628B to scan a UV laser beam focal point across a contaminated surface of an ion source electrode, is situated close to the electrode in question and, as such, is subject to such degradation.

In addition, an effect known as “photo-contamination” occurs when UV light irradiates an optical surface that is contaminated with particulates. The effect arises because energetic UV photons are capable of chemical bond scission and interaction with surface contaminants that aggressively degrade the surfaces of laser optical components. This makes UV laser light poor choice for laser cleaning in the presence of such surface contaminants. Indeed, this is one reason why many manufacturers of UV lasers offer replaceable output windows for their laser systems, which can be readily changed if the window becomes contaminated and suffers from “photo-contamination”.

This problem could become particularly acute in a contamination desorption process employing UV light (e.g. GB 2486628B) because a significant amount of the contaminant material desorbed from an electrode surface in this way will accumulate upon the surface of the surface of optical components (e.g. a mirror) used to direct the UV light onto a contaminated electrode surface. This renders the surface of the optical component very susceptible to degradation from “photo-contamination”. Rapid failure of the optical component can arise and, therefore, rapid failure of the cleaning process. Frequent replacement of the optical components is required as a result, and short service intervals for the MALDI ion source will be needed. This makes existing UV laser cleaning systems expensive to implement.

Inefficiencies arise from the use of UV laser light to clean a contaminated electrode surface by desorption, when one considers optical scattering of light from small particles of desorbed contaminant material. The desorbed material will form a plume of vapour above the target surface, and some of the incident UV laser light will be absorbed and/or scattered by the particles of that vapour thereby removing energy from the incident laser light and degrading the effectiveness of the cleaning process. Of course, the scattering of light from small particles is not limited to UV laser light. However, the predominant scattering process that of Rayleigh scattering the efficiency of which is inversely proportional to the fourth power of the wavelength of the laser light. This means that UV laser light having a wavelength of, for example, 355 nm will be scattered out of the UV laser beam approximately five times more efficiently than will laser light having a wavelength of 532 nm (e.g. visible light). In short, the plume of desorbed contaminant particles created during the UV laser light cleaning process is relatively opaque to UV laser light that produced it. The plume will obscure the target surface thereby degrading the efficiency of the cleaning process.

Laser cleaning by laser desorption of contaminant material is sometimes incorrectly referred to as ‘ablation’ of the impurity material, but is characterized in that only the impurities adsorbed on the surface of an object are removed by desorbing or incinerating without changing or damaging the underlying surface of the object itself. In general, it is used in industry for removing pollutants from metal surfaces.

The present invention aims to provide an improvement over the prior art.

### SUMMARY

At its most general, the invention relates to the laser etching of surfaces of anion source to remove contamination. Laser etching removes contaminants on the electrode surface by physically removing a layer of the electrode substrate. In this way, the surface of the ion source can be cleaned in a simple manner without having to vent and evacuate the housing of the ion source and/or, without having to significantly heat the surface and without requiring desorption of the contaminant (e.g. to have an optical absorption band close to the laser wavelength). Etching of the surfaces of the ion source has the advantage of removing any adsorbed contaminant together with the electrode substrate layer, and thereby concurrently removing any contaminant that is imbedded into the electrode substrate surface or has formed a stronger chemical bond with the substrate surface than have the merely adsorbed contaminants upon that surface.

The invention thereby provides an improvement on other techniques because it removes impurities or contaminants embedded which the surface of a material by physically removing the parts of the substrate layer within which the embedding has taken place. In addition, the invention does not need to rely on the peculiarities of adsorption/desorption properties of the contaminant in question, in order to effectively clean the surface (e.g. it is not required to implement desorption by matching a laser light wavelength to the adsorption band of contaminant material).

The invention does not require raising the temperature of the electrode surface nor does it require coupling the laser energy directly into the contaminant material. Instead, it etches the surface of the electrode and thus removers all contamination on/in the electrode surface, irrespective of its optical characteristics and properties, efficiently and quickly.

For laser surface etching, a laser beam or a short-duration laser pulse(s) may be aimed at a surface and the point/spot where the laser beam/pulse(s) is incident on the surface may be at, or be close to, the focal plane of the laser. This point/spot may be small, typically less than 1 mm in diameter. Typically, only the area inside this focal point/spot is significantly affected when the laser beam. The energy delivered by the laser beam/pulse(s) there may change the surface of the material under the focal point/spot and locally vaporise the material. The etching/ablating light may, alternatively, be delivered as a continuous laser beam rather than as a pulsed laser beam.

In a first aspect, the invention may provide an ion source for a mass spectrometer for generating ions of a sample material comprising: an ionising light source arranged to output ionising light for ionising the sample material; an electrode presenting an electrode surface for attracting the ionised sample material and upon which contaminant material is able to accumulate; an ablating light source arranged to output an ablating light beam or pulse(s) for ablating material of the electrode from the electrode surface, wherein the ablating light beam or pulse(s) does not include said ionising light; a reflector for reflecting the ablating light onto the electrode surface, therewith by a process of ablation a part of the electrode surface is removable from the electrode together with said contaminant material when accumulated upon that part. In this way, ablating light employed for cleaning away contaminant material is free of the light (particularly, UV light) used for ionising a sample material, such as in a MALDI process or the like.

Desirably, the optical frequency of the ionising light is not less than a first threshold frequency. Desirably, the optical frequency of the ablating light beam or pulse(s) is not greater than a second threshold frequency. For example, the first threshold may be a frequency value corresponding to ultra-violet (UV) light (e.g. a wavelength in the range about 10 nm to about 400 nm such that the ionising light may be any frequency equal to or greater than about 750 THz (wavelength equal to or less than about 400 nm). Preferably, the first threshold frequency exceeds the second threshold frequency. The second threshold frequency may be within the visible spectrum of light. For example, the second threshold may be a frequency value corresponding to visible blue light (e.g. a wavelength of about 450 nm) such that the ablating light may be any frequency equal to or less than (wavelength equal to or greater than) that of blue visible light, such as green visible light, red visible light, infra-red light (e.g. near-IR, mid-IR or far-IR). For example, the second threshold may be a frequency value corresponding to visible green light (e.g. a wavelength of about 550 nm) such that the ablating light may be any frequency equal to or less than (wavelength equal to or greater than) that of green visible light, such as green visible light, or red visible light, or infra-red light (e.g. near-IR, mid-IR or far-IR). The relationship between the colour of light and the associated ranges of wavelength, frequency and photon energy are widely regarded in the art as being as set out in the following table:

| Colour | Wavelength | Frequency | Photon energy |
|---|---|---|---|
| Violet | 380-450 nm | 668-789 THz | 2.75-3.26 eV |
| Blue | 450-495 nm | 606-668 THz | 2.50-2.75 eV |
| Green | 495-570 nm | 526-606 THz | 2.17-2.50 eV |
| Yellow | 570-590 nm | 508-526 THz | 2.10-2.17 eV |
| Orange | 590-620 nm | 484-508 THz | 2.00-2.10 eV |
| Red | 620-750 nm | 400-484 THz | 1.65-2.00 eV |

Desirably, the ablating light beam or pulse(s) comprises visible light and/or infra-red (IR) light. It has been found that laser light comprising such wavelengths is particularly efficient at transferring heat rapidly to a targeted and localised spot on an electrode surface upon which the laser beam/pulse(s) makes its footprint (e.g. focal spot). This enables efficient ablation of that spot and enables removal of the electrode material (and contaminant upon it) so quickly that the surrounding material of the electrode absorbs negligible heat and is therefore not heated by the ablation process, practically speaking. This allows efficient cleaning of the electrode without the undesirable side-effects associated with a heating of the surrounding parts of the electrode. The material of the electrode may comprise steel, or aluminium or any other suitable electrode material.

Desirably, the ionising light comprises ultraviolet (UV) light. UV light is desirable for use in ionisation processes due to its high photon energy and is the preferred choice for the desorption of matrix material and the ionisation of analyte material in a MALDI process.

Desirably, the light source for generating the ionising light and the light source for generating the ablating light beam or pulse(s), are the same light source.

Desirably, the light source for generating the ionising light comprises a non-linear optical medium or an optical frequency multiplier arranged to perform harmonic generation. The ionising light may be a harmonic of the light comprising the ablating light beam or pulse(s). The optical frequency multiplier may be arranged to perform second harmonic generation (SHG, also called frequency doubling), and/or third harmonic generation (also called frequency tripling), or sum-frequency generation in which two non-similar frequencies (ω₁, ω₂) of light (e.g. from two separate lasers, or harmonics from one laser) are used to generate light having a frequency (ω₃=ω₁+ω₂) equal to the sum of the two non-similar frequencies.

Although a continuous laser beam may be employed according to embodiments of the invention, it has been found that the use of laser pulses (e.g. a pulse laser beam) is particularly effective in ablating the material of the electrode so as to remove material from the electrode so quickly that the surrounding material of the electrode (or contaminant) absorbs negligible heat from the laser light. This is desirable to avoid unintended heating of the electrode and the possible evaporation of contaminant material therefrom. Parts of the electrode surface yet to be cleaned by the ablation process may otherwise be heated to gently evaporate contaminant material which may then settle back upon a part of the electrode that has just been cleaned, thereby re-contaminating it. Ablation of the electrode surface material and contaminant material upon it, provides a much more kinetically energetic method of removal which is far less prone to such re-contamination.

Desirably, the ablating light source comprises a laser configured to generate laser pulses which have a laser pulse energy density in the range about 1 Jcm⁻¹ to about 5 Jcm⁻¹. These parameter ranges have been found to provide effective results.

Desirably, the ablating light source comprises a laser configured to generate laser pulses at a repetition rate of between about 0.5 kHz and about 2.0 kHz. These parameter ranges have been found to provide effective results.

Desirably, the ablating light source comprises a laser configured to generate laser pulses which have pulse energies in the range about 50 μJ to over about 200 μJ. These parameter ranges have been found to provide effective results.

Desirably, the ablating light source comprises a laser configured to provide a laser focal spot diameter in the range about 20 μm to about 200 μm. These parameter ranges have been found to provide effective results.

Desirably, the ablating light source comprises a laser in optical communication with a beam profiling apparatus configured to transform an input laser beam or pulse(s) from said laser having a Gaussian laser beam intensity profile into an output laser beam or pulse(s) having a substantially square laser beam intensity profile. Provision of a generally flat (e.g. top-hat shape) of laser intensity profile assists in generating a generally flatter and ablation crater (or furrow) shape at a given laser foot-print position (or scan line if scanned) on the electrode surface. The transformation of the pulse profile may be done using diffractive (or other) optical processing means such as would be readily available to the skilled person.

Desirably, the ablating light source comprises a laser in optical communication with a beam profiling apparatus configured to transform an input laser beam or pulse(s) from said laser having a substantially circular beam cross-sectional shape into an output laser beam or pulse(s) having a substantially square cross-sectional shape. The transformation of the cross-sectional shape of the laser beam (or its pulses) means that the foot-print of the laser on the electrode surface has generally the same shape. Accordingly, successive ablation craters, and neighbouring scan lines of such craters, on the electrode surface when cleaned, may more effectively cover the target electrode surface when positioned adjacent to each other thereby reducing the amount of ‘overlap’ required between successive ablation target locations (laser spot positions) during a cleaning operation.

In a second aspect, the invention provides a method for cleaning an ion source of a mass spectrometer for generating ions of a sample material, the ion source comprising an ionising light source arranged to output ionising light for ionising the sample material, and an electrode presenting an electrode surface for attracting the ionised sample material and upon which contaminant material is able to accumulate, the method including; generating an ablating light beam or pulse(s) for ablating material of the electrode from the electrode surface, wherein the ablating light beam or pulse(s) does not include said ionising light; reflecting, by a reflector, the ablating light beam or pulse(s) onto the electrode surface, therewith by a process of ablation removing a part of the electrode surface from the electrode together with said contaminant material when accumulated upon that part.

Desirably, the optical frequency of the ionising light is not less than a first threshold frequency, and the optical frequency of the ablating light beam or pulse(s) is not greater than a second threshold frequency, wherein the first threshold frequency exceeds the second threshold frequency.

Desirably, the ablating light beam or pulse(s) comprises visible light.

Desirably, the ionising light comprises ultraviolet (UV) light.

Desirably, the method comprises using the ionising light source for generating both the ionising light and the ablating light beam or pulse(s).

Desirably, the method includes providing the light source for generating the ionising light with a non-linear optical medium, and therewith performing harmonic generation such that the ionising light is a harmonic of the light comprising the ablating light beam or pulse(s).

Desirably, the method includes generating laser pulses of said ablating light which have a laser pulse energy density in the range 1 Jcm⁻¹ to 5 Jcm⁻¹.

Desirably, the method includes generating laser pulses of said ablating light at a repetition rate of between about 0.5 kHz and about 2.0 kHz.

Desirably, the method includes generating laser pulses of said ablating light which have pulse energies in the range 50 μJ to over 200 μJ.

Desirably, the method includes focusing the ablating light to a laser focal spot diameter in the range about 20 μm to about 200 μm.

Desirably, the method includes transforming a laser beam or pulse(s) of said ablating light having a Gaussian laser beam intensity profile into an output laser beam or pulse(s) of said ablating light having a substantially square laser beam intensity profile.

Desirably, the method includes transforming a laser beam or pulse(s) of said ablating light having a substantially circular beam cross-sectional shape into an output laser beam or pulse(s) of said ablating light having a substantially square cross-sectional shape.

The term ‘about’ when used in this specification refers to a tolerance of ±10%, of the stated value, i.e. about 50% encompasses any value in the range 45% to 55%, In further embodiments ‘about’ refers to a tolerance of ±5%, ±2%, ±1%, ±0.5%, ±0.2% or 0.1% of the stated value.

### BRIEF DESCRIPTION OF DRAWINGS

Examples of embodiments of the will now be described, to allow a better understanding of the invention, with reference to the accompanying drawings comprising the following.

FIGS. 1A and 1B schematically illustrate the operation of an ion source in a mass spectrometer implementing a MALDI process;

FIG. 2 schematically illustrates the operation of an ion source in a mass spectrometer implementing a process of cleaning a contaminated region of an electrode of the ion source using laser etching;

FIG. 3 schematically illustrates a more detailed view of FIG. 2 indicating a relationship between focal points and a reflective curvature of a reflector surface;

FIG. 4(a) schematically illustrates the ion source illustrated in FIG. 1A or 1B, in more detail, implementing a MALDI and indicating the provision of ionising light for that purpose;

FIG. 4(b) schematically illustrates the ion source illustrated in FIG. 2, in more detail, implementing a of cleaning a contaminated region of an electrode of the mass spectrometer, and indicating the provision of an ablating light source for that purpose;

FIG. 5 illustrates an electrode of a mass spectrometer presenting an electrode surface upon which a contaminant material has accumulated, and indicating etched regions of the surface of the electrode from which surface material has been ablated to clean the electrode of the contaminant material;

FIG. 6 schematically illustrates a cross-sectional view of a process of laser ablation of a part of the surface of an electrode of the ion source upon which a layer of contaminant material has accumulated;

FIG. 7A schematically illustrates a cross-sectional view of a part of the surface of the electrode of FIG. 5 showing an etched region adjacent the non-etched region of the surface of the electrode;

FIG. 7B schematically illustrates, for the purposes of comparison, a cross-sectional view of a part of the surface of an electrode of an ion source in which a region of the surface has been etched using ablating light adjacent, to the surface region of the surface which has not been etched;

FIG. 8 schematically illustrates the two separate regions of the optical frequency of light employed in embodiments of the invention in which light of higher frequencies is used for implementing a MALDI process of sample ionisation, whereas light of lower frequencies (which exclude all of the higher frequencies) is used for implementing electrode surface clearing by ablation/etching;

FIGS. 9A, 9B, 9C and 9D show different arrangements for directing ablating light onto a surface(s) of an electrode(s) to be cleaned;

FIG. 10 shows a process for transforming the intensity profile and cross-sectional shape of a laser beam into a ‘top-hat’ profile;

FIGS. 11A, 11B, 11C, and 11D show a process of moving a sample support plate, which bears both a sample plate and a curved reflector, to transition from a MALDI operation to a laser cleaning operation.

### DESCRIPTION OF EMBODIMENTS

In the drawings, like items are assigned like reference symbols.

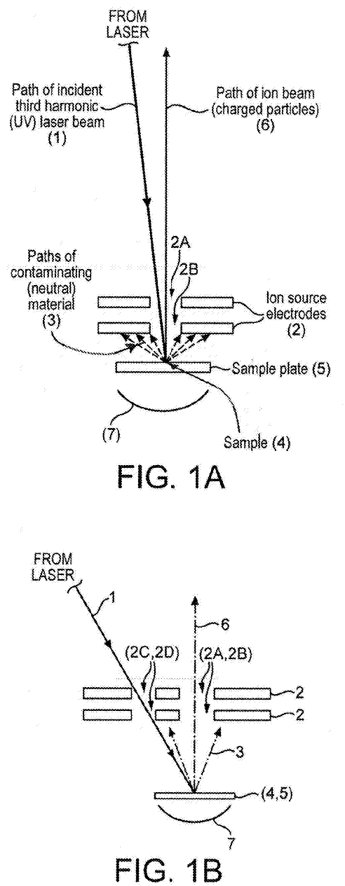

FIG. 1A or 1B schematically illustrates an ion source employed in amass spectrometer (not shown) configured and arranged for providing ions of a desired sample material for analysis using the mass spectrometer. The ion source implements a process of MALDI. A combined sample/matrix (4) comprises a matrix material which encapsulates a quantity of analyte sample material within it. The matrix material may be any known matrix material used in MALDI selected to be efficient at absorbing ionising light from the laser so that it efficiently desorbs from the body of the matrix when struck by the laser light. In so doing, it releases encapsulated analyte material which is also ionised in the process.

The ion source comprises a light source in the form of a laser (not shown) arranged to generate ionising light having a frequency within the ultraviolet (UV) optical frequency range, and for directing the ionising light so as to be incident upon a sample/matrix material (4) disposed upon the surface of a sample plate (5). The frequency of the ionising light is selected for optimising the MALDI process whereby a sample material and its encapsulating matrix material are collectively desorbed from the sample plate in response to absorption of energy from the incident ionising UV light, but whereby the sample material is particularly responsive to the incident UV light to be ionised by it. The result is the production of a plume of material comprising desorbed particles of the matrix material, which are predominantly not ionised (i.e. electrically neutral), and dissolved ions of the sample material (i.e. electrically charged).

A pair of parallel, separate electrodes (2) of the ion source (shown in cross-section) are arranged adjacent to the surface of the sample plate bearing the matrix-encapsulated sample material (4), and are disposed between the sample plate and the laser. The electrode pair comprises two substantially flat and mutually parallel electrode plates of stainless steel, each presenting a flat electrode surface through which a circular through-opening (2A, 2B) passes. The through-openings in the two electrode plates are mutually in register and in register with a matrix-encapsulated sample disposed upon the sample plate (5). In this way, the matrix-encapsulated sample is revealed to the laser (not shown) through the through-openings of the pair of electrode plates thereby allowing ionising UV light to pass from the laser, through the through-openings and to be incident upon the matrix-encapsulated sample disposed upon the sample plate (4).

In arrangements in which the angle of incidence of the laser beam is too high for the matrix encapsulated sample to be revealed to the laser through the through-openings in the electrodes, additional laterally displaced through-openings in one or more of the electrodes (2) may be incorporated to enable the matrix-encapsulated sample to be revealed to the laser.

FIG. 1B schematically illustrates an example, in which each of the electrodes provide not only ion beam through-opening (2A, 2B) for permitting the passage of ions liberated from the matrix-encapsulated sample by a MALDI process, but also a laser beam through-opening (2C, 2D) for permitting the passage of the laser beam (1) from the laser (not shown) to the sample (4) for use in performing the MALDI process and/or for use in performing the cleaning/ablating process described herein.

The plume of matrix/sample material generated by interaction with incident UV ionising light, when fired from the laser at the sample plate via the through-openings of the electrode plates, rises from the surface of the sample plate in a direction generally towards the opposing surface of the nearest electrode plate presented to the sample plate, and towards the through-opening (2B) within it. Application of appropriate electrical potentials to the electrode plates of the ion source electrodes (2) generates an electrical field of shape and intensity appropriate to direct and accelerate the ionised sample material, generated by the ionising UV light, along an ion beam path (6) passing through the through-openings (2A, 2B) of the ion electrodes and towards the ion optics of the mass spectrometer (not shown) with which the ion source is in communication. In this way a source of ions of sample material is provided by the ion source to the mass spectrometer.

However, the plume of matrix/sample material generated by interaction with the incident UV ionising light, also comprises a significant quantity of neutral (i.e. not ionised) material of the encapsulating matrix disposed on the surface of the sample plate. This neutral matrix material does not respond to the electrical field generated by the ion source electrodes, and simply expands thereby to drift towards the facing surfaces of the electrode plates (2) of the ion source electrodes so as to be deposited upon those surfaces. This is to be considered as contaminant material as its presence upon an electrode plate surface interferes with the strength and shape of the electrical field which the ion source electrodes are designed to generate for the purposes of accurately forming and directing a beam (6) of ions of sample/analyte material towards the mass spectrometer, in use. Successive uses of the ion source in this way, results in an undesirable accumulation of such contaminant material upon the electrode plate surfaces.

A curved reflector (7) is provided within the ion source and is arranged to operate in conjunction with ablating light generated by a laser (not shown). The ablating light is not present within the UV light incident upon the sample plate during MALDI processes, but is employed for the purposes of cleaning one or more surfaces of one or more of the electrode plate(s) of the ion source electrodes (2) after (or in between) MALDI processes. The laser used for generating the ablating light is preferably also the laser used for generating the ionising light (UV). However, in some embodiments, the former may be separate from the latter, and may be dedicated to the task of generating ablating light. When the same laser is used to generate both the ionising light and the ablating light, it may be controllable to change its light output as between ablating light and ionising light (UV), or the laser may remain (e.g. both ablating light and ionising light being present in the same initial light generated by it) but its light output is filtered or optically processed such that ablating light is excluded and ionising light is retained, or such that ablating light is retained and ionising light is excluded, selectively as desired.

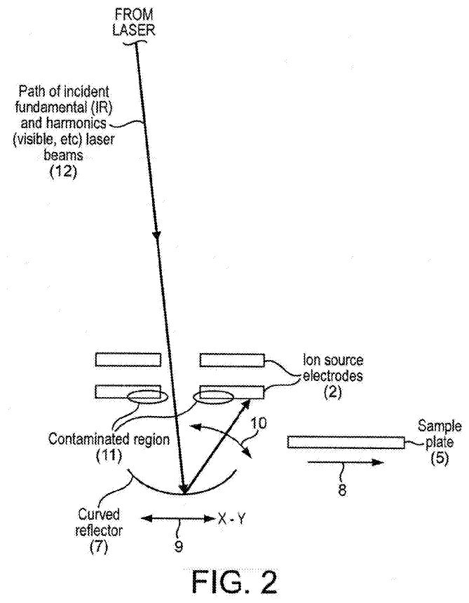

FIG. 2 schematically illustrates the ion source described above with reference to FIG. 1, when operated in a cleaning mode of operation in which a beam (6) of ions of sample material is not generated, but in which a surface of an electrode plate of the ion source electrodes (2) is cleaned of contaminant material (11) which has accumulated upon it. In particular, the sample plate (5) is movably mounted within the ion source so as to be movable from a deployed position in optical communication with the laser (not shown), as shown in FIG. 1A or 1B, to a stowed position shown in FIG. 2 optically isolated from the laser (not shown). The sample plate is arranged to be movable reversibly between the deployed position and the stowed position in a direction (8) transverse to the path (1, 12) along which the laser is arranged to direct incident light upon the sample plate when the sample plate is in the deployed position as shown in FIG. 1A or 1B. The stowed position of the sample plate is a position sufficient to reveal the curved reflector (7) to the through-openings (2A, 2B; or 2C, 2D) of the ion source electrodes (2) thereby to place the curved reflector in the path along which incident light will be directed by the laser. Furthermore, the stowed position of the sample plate is a position sufficient to also reveal to the curved reflector at least a part of a surface of an electrode plate (2) of the ion source electrode which is otherwise presented to, or exposed to, the sample plate (5) when in the deployed position shown in FIG. 1A or 1B.

Consequently, when the sample plate is in the deployed position (FIG. 1A or 1B) the curved reflector (7) is not in optical communication with the laser, being optically isolated from the laser by the sample plate. Conversely, when the sample plate is in the stowed position (FIG. 2), the curved reflector is in optical communication with the laser (not shown) via the through-openings formed within the electrode plates of the ion source electrodes.

The curved reflector is configured and arranged to reflect incident light from the laser in a direction towards a surface, or surfaces, of one or more of the electrode plates of the ion source electrodes. The surfaces in question are those surfaces of the electrode plates which are presented in a direction towards the curved reflector and upon which contaminant material (11) has accumulated, or is able to accumulate. The curved reflector is movably mounted within the ion source so as to be reversibly movable in a direction (9) transverse to the path along which the laser is arranged to direct an incident laser beam (12) upon the curved reflector. The effect of such transverse movement of the curved reflector is to change the optical angle of incidence of an incident laser beam (12) relative to the local normal (i.e. the line perpendicular to the local reflector surface) at the particular part of the curved reflector were the laser beam strikes it. Consequently, by changing the angle of incidence, transverse movement of the curved reflector thereby also changes the angle of reflection of the incident laser beam away from the curved reflector and, as a result, changes the angular direction (10) of the reflected laser beam towards an opposing contaminated electrode surface. This enables scanning of the reflected laser beam (12) across services of the opposing ion source electrode plates, as desired, for the purposes of cleaning the surfaces of contaminant material.

In the example illustrated in FIG. 2, the curved reflector presents a concave curvature towards the opposing ion source electrodes. Consequently, transverse movement of the curved reflector in a direction towards one particular side of a through-opening in the surface of an electrode plate causes the reflected laser beam (12) to be scanned in a direction towards that particular side of the plate. However, in other examples, the curved reflector may present a convex curvature towards the ion source electrodes. In such an alternative example, transverse movement of the curved reflector in a direction towards one particular side of a through-opening in the surface of an electrode plate causes the reflected laser beam (12) to be scanned in a direction away from that particular side of the plate.

The curved reflector is transversely movable in any direction within a plane (denoted the “X-Y” plane in FIG. 2) transverse to the path of the incident laser beam, thereby permitting a transverse movement to scan the reflected laser beam in any direction across the opposing surface of the ion source electrode in question. In other examples, the curved reflector may be replaced by a plane reflector which is pivotable about an axis or a plurality of axes (e.g. orthogonal axes) to reflect the incident laser beam in desired directions. However, the simplicity of employing transverse translation of a curve reflector is advantageous in terms of simplicity of implementation and reduced complexity/cost.

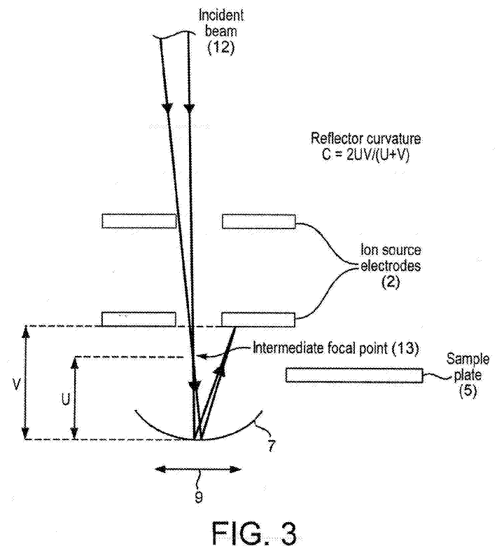

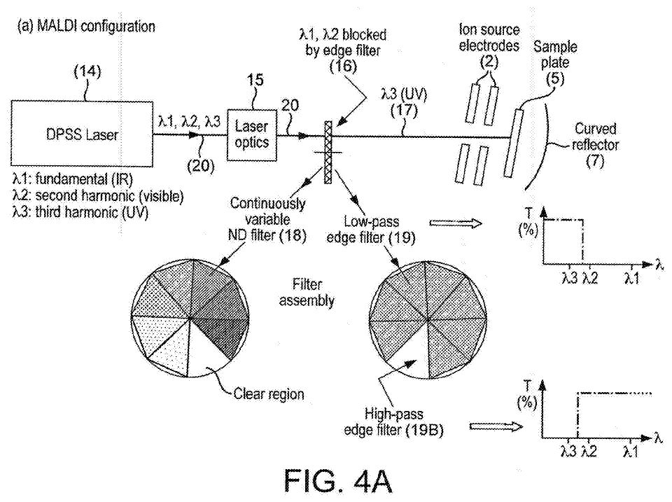

FIG. 3 schematically illustrates a more detailed view of FIG. 2 in which the optical cooperation between the curved reflector (7), the structure of the incident laser beam (12) created by the laser (not shown), and the plates of the ion source electrodes (2), is exemplified as follows. The laser optics of the laser (see item 15 of FIG. 4(a) or FIG. 4(b)) are constructed and arranged to form within the incident laser beam (12) and intermediate focal point (13) disposed before (or after) the curved reflector (7) along the path of the incident laser beam at a distance ‘U’ from that part of the curved reflector from which reflection is intended. The surface of the ion source electrode upon which it is intended to subsequently finally focus the incident laser beam is disposed at a distance ‘V’ from that part of the curved reflector from which reflection is intended. The radius of curvature ‘C’ of the curved reflector, which is substantially constant at those parts of the curved reflector where reflection is intended to occur, as given by the following equation: C=2UV/(U+V).

Consequently, because the quantity ‘C’ is known, the quantity ‘U’ may be controllably varied by appropriately controlling the focusing function of the laser optics of the laser thereby to control the size of the quantity ‘V’ which locates the position of the final focus the laser beam. In particular, this control may be implemented according to the following equation: V=CU/(2U−C). In preferred embodiments, the ion source is arranged to control the position of the intermediate focal point (13), thereby controlling the value of the distance ‘U’, in such a way as to appropriately control the position of the final focus of the laser beam, relative to the curved reflector (7). In this way, the laser optics (15) may be arranged to adjust the final focus of the reflected laser beam at the surface of an ion source electrode plate (2). This adjustment may be for the purposes of, for example, slightly de-focusing the laser beam at the surface of the ion source electrode plate so as to broaden the “footprint” or “spot size” of the laser beam where it strikes the electrode plate surface. Alternatively, or in addition, this adjustment may be to allow the reflected part of the incident laser beam to be selectively focused upon different selected ion source electrode plates (2A, 2B) which might be located at different distances from the curved reflector. An example is schematically illustrated in the drawings, which illustrate two successive parallel electrode plates (2A, 2B) disposed at different distances from the curved reflector.

FIG. 4(a) and FIG. 4(b) schematically illustrate an ion source according to a preferred embodiment of the invention including the ion source electrodes (2), the sample plate (5), and the curved reflector (7) of the embodiments described above with reference to FIGS. 1 to 3. In these figures the light source is illustrated in detail. In FIG. 4(a), the ion source is shown operating in a MALDI operation for the production of a beam (6) of ions of sample (analyte) material as is described above with reference to FIG. 1. In FIG. 4B, the ion source is shown operating in an electrode surface etching mode for the cleaning of contaminant material from ion source electrode surfaces such as is described with reference to FIGS. 2 and 3 above.

The light source comprises a laser (14) arranged to generate light of a fundamental harmonic (λ1) which has a wavelength lying within the spectral range of infrared (IR) light. The laser comprises a non-linear optical medium arranged to perform harmonic generation using the fundamental harmonic of light generated by the laser so as to generate the second harmonic (λ2) and the third harmonic (λ3) from the fundamental harmonic of the laser light. The second harmonic has a wavelength one half that of the fundamental harmonic and corresponding to a wavelength lying within the spectral range of visible light, whereas the third harmonic has a wavelength one third that of the fundamental harmonic and corresponding to a wavelength lying within the spectral range of ultraviolet light. For example, the laser may be arranged to generate a fundamental harmonic having a wavelength of 1064 nm, such that the second harmonic has a wavelength of 532 nm, and the third harmonic has a wavelength of 355 nm. A suitable non-linear optical medium for harmonic generation includes any of: lithium niobite; Lithium triborate (LBO); β-barium borate (BBO); potassium dihydrogen phosphate (KDP); potassium titanyl phosphate (KTP).

The laser (14) is arranged to output the fundamental harmonic, the second harmonic and the third harmonic of light as a single output beam or pulse(s) (20) containing al three harmonics. A laser optics unit (15) is arranged in optical communication with the output of the laser (14) so as to receive the single output beam or pulse(s) from the laser. It is arranged to apply beam shaping to the cross-sectional intensity profile of the laser beam or pulse(s) as well as to focus the laser beam or pulse(s) to an appropriate focal point coinciding with the position of a matrix-embedded sample material disposed on a surface of the sample plate (5) of the ion source, when the sample plate is in the deployed position. Located along the optical beam path of the laser beam or pulse(s), between the position of the laser optics unit (15) and the ion source electrodes (2), is a filter unit (16) comprising a continuously variable neutral density filter (18) which is operable (e.g. rotatable) to controllably and variably attenuate the intensity of the laser beam or pulse(s) transmitted through it. The neutral density filter is continuously variable between a condition of about 100% attenuation to 0% attenuation (or approximately that: i.e. negligible attenuation), selectively by the user.

Following the neutral density filter (18), along the beam path of the laser beam or pulse(s), is disposed a low-pass edge filter (19) which comprises an optical transmission-characteristic (T)/pass-profile (see inset “T (%)” for filer 19 in FIG. 4(a)) which blocks passage of the longer-wavelength fundamental harmonic and the second harmonic of the light present within the laser beam or pulse(s) incident upon it. This means that only the shorter-wavelength third harmonic of laser light, namely ultraviolet light, is able to pass through the low-pass edge filer (i.e. ‘short’-pass, for transmitting shorter wavelength and blocking longer wavelengths) for propagation as a UV laser beam (17) directed upon the sample plate (5) as desired for implementing a MALDI process.

FIG. 4(b) schematically illustrates a second mode of operation of the ion source of FIG. 4(a), in which a MALDI process is no longer performed, and instead a cleaning process is underway. In order to enter this second mode of operation, the sample plate (5) is moved to the stowed position thereby revealing from behind it the reflective surface of the curved reflector (7). In addition, the high-pass edge filter (196) of the filter assembly (16) is used to apply a high-pass (or ‘long-pass’) edge filter profile which blocks the third harmonic but passes the fundamental harmonic and the second harmonic of the laser light produced by the laser unit (14). The transmission characteristic (T) of the high-pass filter (196) are such that it blocks the shorter wavelengths of light corresponding to the third harmonic, but passes the longer wavelengths of light corresponding to the fundamental harmonic and the second harmonic of the laser light (see inset “T (%)” for filter 19B in FIG. 4(a)). The result is to cease the ionising UV laser beam or pulse(s) (17) and to replace it with ablating laser beam or pulse(s) (21) comprising infrared light and visible light. The reflective surface of the curved reflector (7) bears a dielectric coating configured (e.g. tuned) to reflect both the fundamental harmonic and the second harmonic of the laser light produced by the laser unit (14).

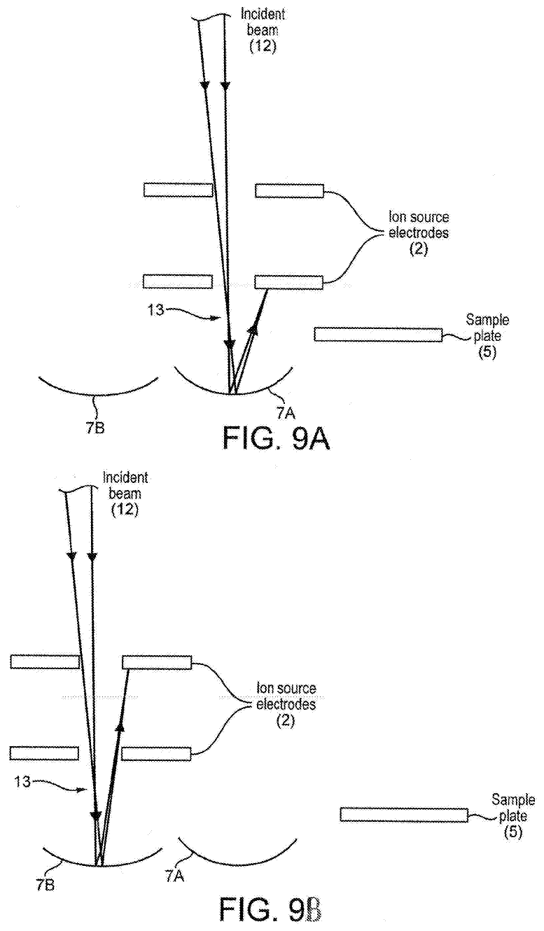

Consequently, the fundamental harmonic and the second harmonic of laser light are employed in a process of ablating material of an ion source electrode plate from the surface of the plate such that a part of the electrode surface is removed from the electrode together with any contaminant material accumulated upon that part. As a result, all wavelengths of light used for the ablation/etching employed in cleaning electrode surfaces entirely exclude wavelengths of light use for ionisation of sample material employed in a MALDI process. FIG. 8 schematically illustrates the separation of wavelengths employed for these two processes, in which wavelengths of ionising light used in the MALDI are explicitly shorter wavelengths which always exceed a first frequency threshold value (i.e. short wavelength) and wavelengths of ablating light used in the cleaning process never exceed a second frequency threshold value (i.e. longer wavelength).

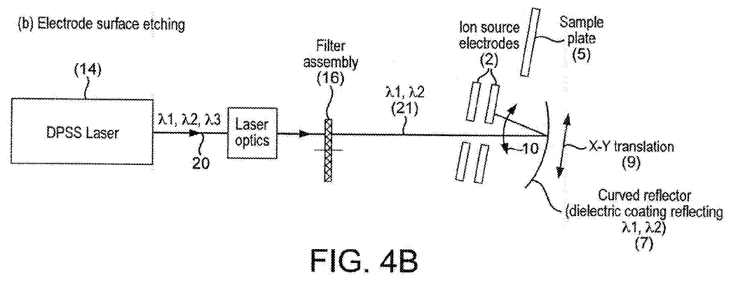

FIG. 5 illustrates a surface of an ion source electrode plate which has, in use, been presented towards a sample plate (5) during a MALDI process, such as is described above, and has accumulated a patina of contaminant material (25) arranged around the through-opening (22) of the electrode plate. This has resulted from plumes of neutral particles of desorbed encapsulation material present in the expanding plumes of material generated when ionising UV light is fired through the through opening (22) at an opposing sample plate (5) in the manner described above with reference to FIG. 4(a). Also displayed on the surface of this electrode plate are lines etched across the plate surface in accordance with the procedures and apparatus illustrated above with reference to FIG. 4(b).

The ablating light transmitted through the high-pass edge filter (19B), comprising the fundamental harmonic and second harmonic of the laser light generated by the laser unit (14) has been focused upon the surface of the electrode plate and scanned across it in a linear scan pattern according to the transverse translation (9) motion of the curved reflector (7) as described above with reference to FIGS. 2, 3 and 4(b). The result is that lines (23) are etched into the surface of the material of the ion source electrode plate were a part of the plate is removed together with the contaminant material accumulated upon that part. For comparison, lines (24) are also etched, by the same process, into surface regions of the source electrode plate where substantially no contaminant material is present.

The effectiveness of the laser etching method is illustrated in FIG. 5, in which lines were etched into the surface of a stainless steel electrode by a linear scan of the laser beam over the surface located in the focal plane of the laser. The laser used was an Nd:YAG with output wavelengths of the fundamental harmonic (1064 nm) and second harmonic (532 nm), running at 1 kHz repetition rate and scanning over the electrode surface at ˜10 cms⁻¹. The width of the etched lines is 50-100 μm. Lines are shown etched into a clean part of the electrode to demonstrate that the method is indeed etching the surface of the metal and not just removing surface contamination. Lines are also shown etched through the contaminated region of the electrode (circle of ˜1 cm diameter) to demonstate that contamination is efficiently removed from the electrode surface during the etching operation. Clearly, scanning the laser over the contaminated area in an X and Y raster, using the method described herein, will enable the entire area of contamination to be etched and the surface contamination completely removed. In the example described herein, to clean an area of 1 cm², with the laser etching a line of width of 50 μm with each linear translation, a raster of 200 lines would be required, giving a total travel of the laser beam over the electrode surface of 50 cm. For a linear translation speed of 10 cms⁻¹, even allowing for the turnaround time for each raster line, the whole process may only take a few seconds. The whole process of placing the sample plate in the stowed position, or removing the sample plate e.g. into a load-lock, performing the etching operation on one or more surfaces, retuning the sample plate to the deployed position, and returning instrument to operating conditions, can be achieved in 5-10 minutes.

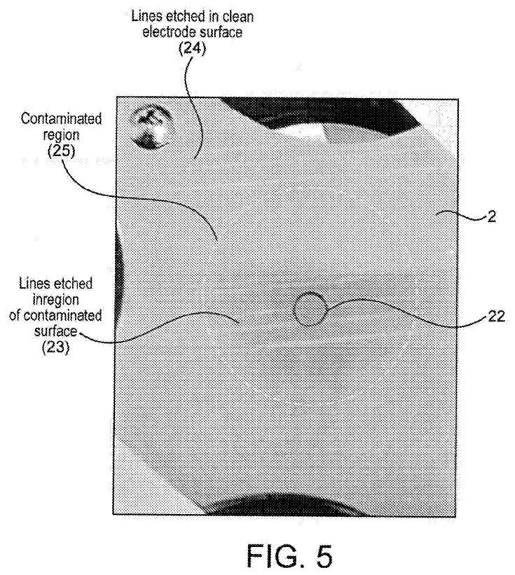

FIG. 6 schematically illustrates the action scanning (10) the focus of the ablating laser beam (12) across the contaminated surface of the ion source electrode (2) thereby ablating particles (27) of material of the electrode to remove that material from the surface of the electrode together with particles (28) of contaminant material (26) which have accumulated upon that surface. A fresh, clean (etched) electrode surface (29) is thereby revealed which is below the previous service level (30) of the pre-etched electrode surface. The fresh electrode surface may bear a shallow pattern of bumps or mild protrusions which corresponds to the edges of surface craters formed by the ablation action of successive laser pulses at successive, neighbouring scan positions along the surface of the electrode.

Because the fundamental harmonic and the second harmonic of the laser light are employed in the clearing process, this means that a far higher proportion of optical energy may be conveyed in each pulse of laser light fired at the surface being cleaned. This is because the fundamental harmonic of the laser carries a high proportion of the total energy output of the laser, as compared to any one of the higher harmonics such as the second harmonic or the third harmonic. Similarly, the second harmonic of the laser carries a higher proportion of the total energy output of the later as compared with any higher harmonic, such as the third harmonic. As a result, when the fundamental harmonic and the second harmonic are used in combination, they collectively convey far more energy per pulse that is conveyed by the third harmonic alone. For example, approximately speaking, the laser unit (14) may typically convey about six times more energy per pulse than is conveyed by the third harmonic alone.

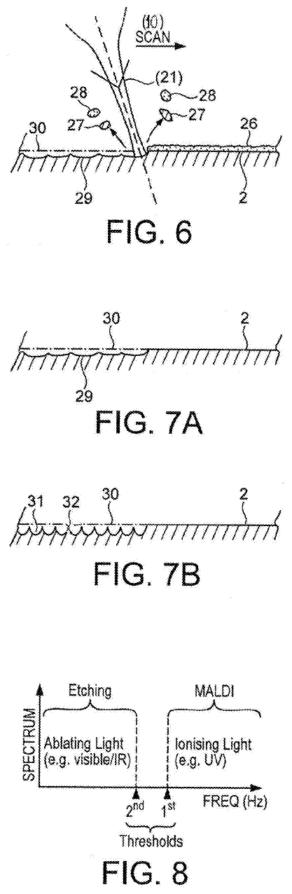

A direct consequence of this is that the diameter of the laser beam at its final focus upon the surface of the electrode may be greater than the diameter of the laser beam that could be used if only the third harmonic (or any higher harmonics) were present within the laser beam. It is therefore much more viable to shape the intensity profile of the laser beam, in cross-section, so that it is flatter across the mid regions and has a more uniform distribution of intensity across its profile than would otherwise be viable in laser beams convey less energy such as would be the case where only the third harmonic employed (and/or any higher harmonics). This enables the invention to provide ablation craters (29) which are much flatter and broader, with much shallower edge protrusions (i.e. crater wags) than would be possible if only the third harmonic of UV laser light had been employed for the cleaning process. The much tighter focus required of UV laser light results in a much deeper ablation crater (31) with steeper crater wags (32) resulting in far sharper bumps/protrusions between adjacent ablation craters on the ablated surface (30) of an electrode (2). FIGS. 7A and 7B provide a schematic comparison of typical ablation crater shapes, in cross-section, formed in the surface of an electrode resulting from implementation of the present invention (FIG. 7A) as compared to implementation when using ultraviolet light (FIG. 7B).

It is most desirable that the surface of an ion source electrode cleaned by such an etching process is as flat and smooth as is possible. This is because successive cleaning operations are rendered more efficient if the surface being cleaned is as flat as possible such that the surface profile of the electrode surface being cleaned deviates as little as possible from the position of the focal spot of the ablating laser light. If the surface of the electrode being cleaned is heavily pockmarked by ablation craters, then the electrode surface will indeed deviate substantially from the position of the focal spot of the ablating laser beam during the scan process and this will reduce the efficiency of the cleaning operation. Furthermore, the roughening of the electrode surface which would result from being pockmarked by deep UV ablation craters, may also degrade the ability of the electrode surface to support the electric field required for the focusing and directing of sample ions (6) with the desired accuracy.

The laser unit (14) may be a short pulse DPSS (Diode Pumped Solid State) laser. Suitable laser examples include Nd:YVO4, Nd:YLF or Nd:YAG lasers. The fundamental harmonic wavelength may be 1064 nm. The harmonics of the laser light may be generated from the lasers fundamental wavelength by non-linear crystal media within the laser device and the fundamental and/or one or more harmonics can be emitted simultaneously from the device.

The ion source may be employed, for example, in a MALDI-TOF mass spectrometer utilising the UV third harmonic of a DPSS laser (e.g. 355 nm output from Nd:YAG laser, 349 nm or 351 nm from Nd:YLF laser). The fundamental (IR) and second harmonic (visible) outputs are attenuated by filters as shown in FIG. 4(b), so the only light output is the UV third harmonic is used for the MALDI process. In the preferred embodiments described above, the same laser is used for both the MALDI and etching operations, without compromising performance of either. However, the method is not limited to a single laser implementation and would work equally well with two lasers, one dedicates to the MALDI process and the second to the etching operation.

The laser system is switchable between the MALDI and surface etching operations. For the MALDI configuration (FIG. 4(a)), only the UV laser output is transmitted to the sample plate (usually at an angle of between 3° and 30° to the normal). The analyte/sample is desorbed and ionised and the ionised molecules accelerated through the apertures/though-openings in the ion source electrodes by potentials applied to the electrodes. However, most of the plume of desorbed material is not ionised and generally continues to expand from the sample spot until it is deposited on surfaces of the electrodes within the ion source. For the surface etching configuration (FIG. 4(b)) the sample plate is stowed (possibly removed; possibly stored in a load-lock) and the laser light, of required wavelengths for etching (fundamental and/or second harmonic), are transmitted to a curved reflector positioned below the plane of the sample plate and mechanically linked to an X-Y translation stage. The reflected laser beam is scanned across the electrode surface by X-Y translation of the curved reflector, typically in a raster pattern.

A dielectric optical coating may be disposed upon the reflective surface of the curve reflector, designed for high reflectivity at the ablating/etching laser wavelengths. A dielectric mirror coating is preferred for this method since it is possible to design for high reflectivity at the required wavelengths and is more robust than the alternative broadband metal mirror coatings. If more than one surface requires etching then either:
(i) Multiple reflectors can be mounted on the translation stage with appropriate curvatures;
(ii) The front and back surfaces of a single reflector may be utilised to reflect different wavelengths onto two different surfaces
(iii) The value of ‘U’ (see FIG. 3) can be adjusted, for each surface to be etched, by adjusting optics earlier in the laser optics train as discussed with reference to FIG. 3 above; or
(iv) Set the laser focus at an intermediate position between two surfaces to be etched if the energy density at each surface is still sufficient to etch the surfaces to be cleaned.

There can be a benefit in etching the electrode surface with a part of the laser beam which is slightly away from the laser focus in so far as the larger beam size allows a larger area to be etched with a single pass of the laser over the surface, thus reducing total number of laser shots required and the total cleaning time. It is apparent that this method will be most effective with plane electrode geometry.

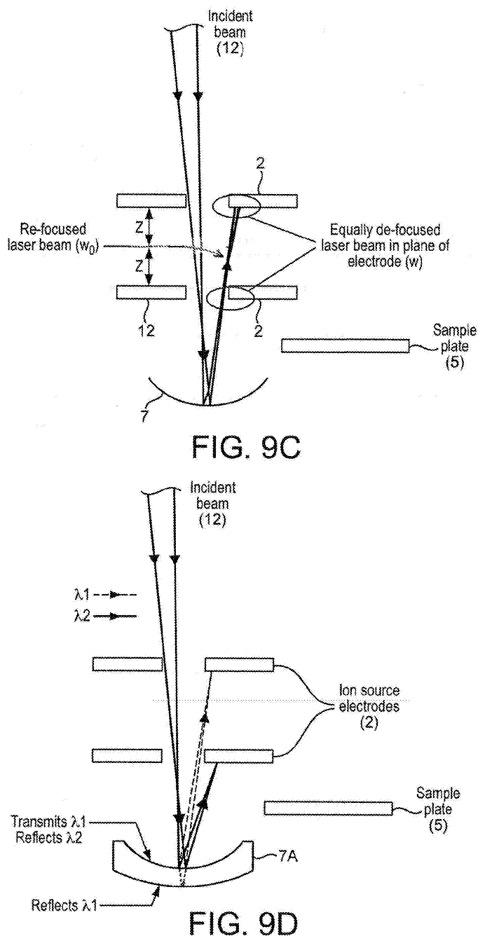

FIGS. 9A and 9B illustrate as example of the method (i) indicated above. Here two mirrors (7A, 7B) are mounted on a movable stage (e.g. the sample stage), and each is formed with appropriate curvatures to focus the laser beam (12) onto a respective one of two different surfaces of a respective two separate electrode plates the ion source electrode system. Thus, these surfaces can be etched consecutively by raster scanning each one of the two mirrors, in turn, beneath the incident laser beam (12). The moveable stage is translated transversely to the direction of the laser beam to cause the focal spot of the reflected laser beam to raster-scan across the target electrode surface in a reciprocal fashion. In FIG. 9A, one of the two mirrors having higher curvature is employed to focus the laser light (12) upon a nearest electrode surface, whereas in FIG. 9B, the other one of the two mirrors having a relatively lower curvature is employed to focus the laser light (12) upon a farthest electrode surface.

FIG. 9C illustrates an example of method (iv) described above. Here the laser beam (12) is re-focused by the reflector surface (7) to an intermediate point between two electrode surfaces to be cleaned. The energy density of the laser mean at points along the beam path coinciding with the distances to the two electrode surfaces, and at opposite sides of the focal point of the beam, is made sufficient allow the two surfaces to be etched simultaneously by raster scanning the single reflector (7). The size of the defocused laser beam (w(z)), and thus its energy density, at the electrode surfaces can be readily calculated from:

$$w ( z ) = {w}_{0} \sqrt{1 + {( \frac{z}{{z}_{0}} )}^{2}}$$

Where w(z) is the beam radius (e.g. at the 1/e² energy level of a Gaussian beam profile) at the electrode surface at a distance z from the beam focus. The quantity w₀ is the beam radius at the beam focus at the intermediate position between the two electrodes (2) separated by a distance 2z, and z₀ is a parameter know as the Rayleigh range given by:

$${z}_{0} = \frac{π {w}_{0}^{2}}{λ}$$

Thus, the laser beam relative energy density at an electrode surface, with respect to that at the focus point between the electrodes, is given by (w₀/w(z))². FIG. 9D illustrates the example of the method described in (ii) above. Here, laser light (12) of wavelength λ1 (e.g. fundamental harmonic) and λ2 (e.g. second harmonic) are pass directed onto the same one reflector (7). The curvature of the first (upper) surface of the reflector, and an optical coating applied to that surface, are optimised to reflect and focus light of wavelength λ2 into the plane of the first electrode surface (2) facing the reflector but nearest to the reflector, whilst transmitting light of wavelength λ1. The curvature of the second (rear) surface of the reflector, and the optical coating applied to it, are optimised to reflect and focus light of wavelength λ1 into the plane of the second electrode surface (2) facing the reflector but furthest from the reflector.

Most preferably, only a UV laser output should be incident on the sample during the MALDI process because the other wavelengths (fundamental harmonic and second harmonic) will not be efficiently absorbed by the matrix and will couple energy directly into the analyte giving rise to undesirable metastable fragmentation. Several methods can be used to select the required laser wavelengths (e.g. using selectable wavelength filters), for each operation.

During the MALDI operation, it is preferable to fine-adjust/optimise the pulse energy of the UV laser beam. This may be achieved, as described above, using a continuously variable metallic ND (Neutral Density) filter (e.g. 18; FIG. 4(a)) that is coated on one surface of a circular fused silica substrate. The ND filter coating is typically applied over an angle of, for example 330°, leaving a segment of 30° uncoated (e.g. item 18, ‘clear region’; FIG. 4(a)). The filter may be rotated so that the UV laser beam is incident on the appreciate part of the ND filter to transmit the required UV laser pulse energy. In preferred embodiments, an additional optical coating is applied to the second surface of the substrate over an area corresponding to that of the ND filter coating on the first surface. The clear segment region on the first surface is coincident (in register) with the high-pass filter segment region on the second surface. The coating on the second surface, coincident with the ND filter on the first surface, attenuates the IR fundamental and visible second harmonic wavelengths whilst transmitting the third UV harmonic. This can readily by achieved with a low-pass edge filter (19B), which only transmits wavelengths shorter than a defined cut-off wavelength. This provides the filter 19 and 19B of FIG. 4(a). The first coating (18) provides energy control while the performing a MALDI operation, and the second coating (19, 19B) provides wavelength control for performing MALDI or for performing etching. Other filter methods could achieve the same function.

During the MALDI operation (FIG. 4(a)) all laser output wavelengths (IR, visible and UV) are incident on the filter assembly. The filter is rotated to control the UV pulse energy with the first surface variable ND filter and the IR fundamental and visible harmonic wavelengths are attenuated by the second surface edge filter (19B). Thus, only UV light of the required pulse energy will irradiate the sample plate for MALDI analysis. The filter assembly can be located before, after, or incorporated within the other laser optic components, but care should be taken to ensure the laser beam diameter, at the filter, is large enough to ensure the pulse energy density is below the damage threshold of the ND and edge filter coatings.

During the surface etching operation (FIG. 4(b)) all laser output wavelengths (IR, visible and UV) are again incident on the filter assembly. For etching, the filter is rotated so that the laser light is incident on the clear region of the first surface and passes onto the high-pass edge filter on the second surface. This, light of the fundamental harmonic and the second harmonic, but not the third UV harmonic, is transmitted through the filter and reflected and focused onto the electrode surface by the curved reflector. The curved reflector is coated with a dielectric mirror coating optimised to reflect the fundamental and/or second harmonic wavelengths (IR, visible) required for the etching operation.

In practice, for the commonly used MALDI DPSS lasers, the fundamental wavelength will be in the IR range 1046 nm to 1053 nm, the second harmonic in the visible (green) range 525 nm to 532 nm and the third harmonic in the UV range 349 nm to 355 nm. Although these wavelengths are associated with commonly used MALDI lasers, the laser etching process is not restricted to the fundamental harmonic and second harmonic wavelengths quoted above, and will work equally well with laser wavelengths outside the UV spectral range, either using the MALDI laser or a second laser fitted to the mass spectrometer for the etching process.

The method has been found to effectively etch stainless-steel substrates with laser pulse energy densities in the range 1 Jcm⁻¹ to 5 Jcm⁻¹ with a 1 kHz repetition rate laser, which can readily be achieved with the MALDI lasers, which typically have pulse energies in the range 50 μJ to over 200 μJ configured with laser focal spot diameters in the range, but not limited to, 50 μm to 100 μm. A laser could be used with a pulse energy outside this range with the laser focus focal spot adjusted appropriately to achieve the required energy density. In practice, an electrode surface area of 10 cm² can be effectively etched in 10 minutes with a laser pulse energy of 100 μJ, focused to spot size of 100 μm and operating at a repetition rate of 1 kHz.

The efficiency of the cleaning method described may be enhanced by employing established laser beam shaping technology (e.g. diffractive, refractive or apodizing) to transform a typically Gaussian laser beam profile into a ‘top hat’ square profile and transforming the round beam cross-section into a square cross-section.

This approach would reduce the degree of overlap required between adjacent laser scans, thus reduce the total number of scans, reduce the total number of laser shots required and thus reduce the total time required to etch a given area. Not only is it a benefit that the cleaning process can be carried out relatively quickly using this method, but also because it only uses a small number of laser shots, typically ˜2×10⁵. This is only 0.02% of a typical laser liftime, which is of the order of 10⁹ pulse shots. Thus, many cleaning cycles can be carried out without significantly impacting on the laser lifetime. Indeed, it would be practical to automatically run the cleaning process periodically, when the instrument is idle (possibly defined by a user, e.g. overnight) at intervals, such as after a specific number of laser shots have elapsed. Proactive cleaning is also possible and for some applications may be preferable to waiting for the instrument to show significant degradation in performance before performing the cleaning operaton. Certainly, the quick cleaning time and minimum impact on laser lifetime, offered by the invention provides significant advantages.

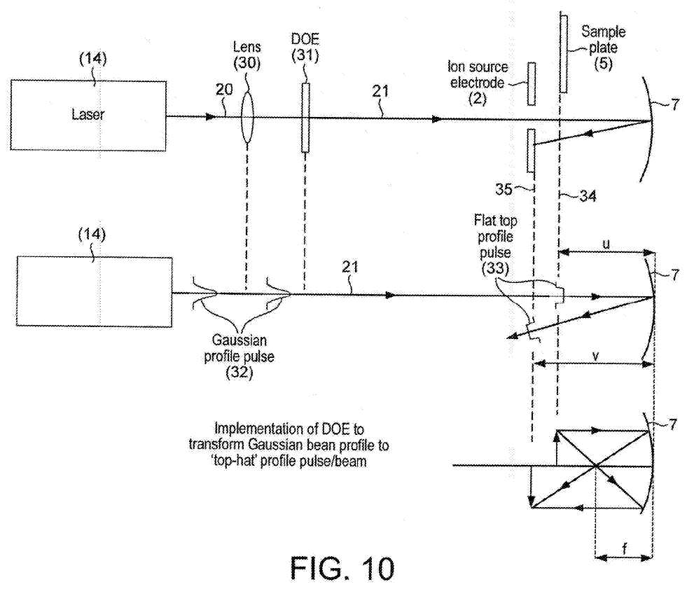

With reference to FIG. 10, a suitable method for beam transformation is to employ a ‘diffractive optical element’ (DOE), which transforms both the energy profile and the cross-section of the laser beam/pulse(s). For example, the transformation may be from a Gaussian intensity profile to a top-hat (or flat-top) intensity profile, and the cross-sectional shape of the beam/pulse(s) may be from round shape to a square shape. An apodizing filter and/or refractive elements may be used in the alternative, however these generally only transform the energy/intensity profile and not the cross-sectional shape of the beam/pulse(s). FIG. 10 schematically shows an implementation of a DOE to transform the laser beam intensity profile from a Gaussian profile to a ‘top-hat’ profile. In the simplest implementation, the Gaussian laser output (20) from the laser (14) is focused by a lens (30) into/at the plane of the sample plate (shown by a dashed line 34). Inserting a DOE (31) between the lens (30) and its focal plane, coincident with the plane of the sample plate (dashed line), transforms the Gaussian beam profile (32) into a top-hat profile (33). The top-hat profile is re-imaged in the plane of an electrode surface (shown by a dashed line 35) by the curved reflector (7) according to the thin lens formula (1/f=1/u+1/v), where f is the focal length of the curved reflector (7) and u and v the distance from the plane (34) of the sample plate and the plane (35) of the electrode surface to the mirror vertex, respectively.

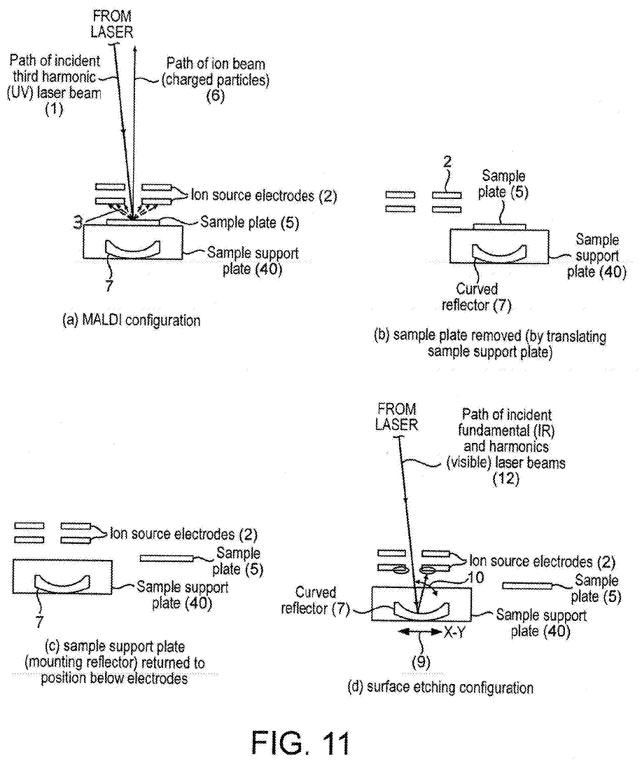

FIG. 11(a) schematically shows a MALDI configuration with sample plate (5) mounted on sample support plate (40). In FIG. 11(b), the source of ionising laser light (1) is switched off, and the sample support plate (40) is moved to place the sample plate (5) to the sowed position in preparation for etching process. Thus, the sample plate (5) is moved by the sample support plate (40). In FIG. 11(c), the sample support plate (40) is returned to the original location it had during the MALDI configuration. Because the sample mounting plate also has the curved reflector (7) mounted upon it, the curved reflector is thereby deployed into the active position. FIG. 11(d) shows the curved reflector subsequently being used in the cleaning/etching process according to the invention.

Although a few preferred embodiments of the present invention have been shown and described, it will be appreciated by those skilled in the art that various changes and modifications might be made without departing from the scope of the invention, as defined in the appended claims.

1. An ion source for a mass spectrometer for generating ions of a sample material comprising:
an ionising light source arranged to output ionising light for ionising the sample material;
an electrode presenting an electrode surface for attracting the ionised sample material and upon which contaminant material is able to accumulate;
an ablating light source arranged to output an ablating light beam or pulse(s) for ablating material of the electrode from the electrode surface, wherein the ablating light beam or pulse(s) does not include said ionising light;
a reflector for reflecting the ablating light onto the electrode surface, therewith by a process of ablation a part of the electrode surface is removable from the electrode together with said contaminant material when accumulated upon that part.

2. The ion source according to claim 1 in which the optical frequency of the ionising light is not less than a first threshold frequency, and the optical frequency of the ablating light beam or pulse(s) is not greater than a second threshold frequency, wherein the first threshold frequency exceeds the second threshold frequency.

3. The ion source according to claim 1 in which the ablating light beam or pulse(s) comprises visible light and/or infra-red (IR) light.

4. The ion source according to claim 1 in which the ionising light comprises ultraviolet (UV) light.

5. The ion source according to claim 1 in which the light source for generating the ionising light and the light source for generating the ablating light beam or pulse(s), are the same light source.

6. The ion source according to claim 1 in which the light source for generating the ionising light comprises a non-linear optical medium arranged to perform harmonic generation and the ionising light is a harmonic of the light comprising the ablating light beam or pulse(s).

7. The ion source according to claim 1 in which the ablating light source comprises a laser configured to generate laser pulses which have a laser pulse energy density in the range 1 Jcm-1 to 5 Jcm-1.

8. The ion source according to claim 1 in which the ablating light source comprises a laser configured to generate laser pulses at a repetition rate of between 0.5 kHz and 2.0 kHz.

9. The ion source according to claim 1 in which the ablating light source comprises a laser configured to generate laser pulses which have pulse energies in the range 50 μJ to over 200 μJ.

10. The ion source according to claim 1 in which the ablating light source comprises a laser configured to provide a laser focal spot diameter in the range 20 μm to 200 μm.

11. The ion source according to claim 1 in which the ablating light source comprises a laser in optical communication with a beam profiling apparatus configured to transform an input laser beam or pulse(s) from said laser having a Gaussian laser beam intensity profile into an output laser beam or pulse(s) having a substantially square laser beam intensity profile.

12. The ion source according to claim 1 in which the ablating light source comprises a laser in optical communication with a beam profiling apparatus configured to transform an input laser beam or pulse(s) from said laser having a substantially circular beam cross-sectional shape into an output laser beam or pulse(s) having a substantially square cross-sectional shape.

13. The ion source according to claim 1 comprising a plurality of separate said electrodes each presenting a respective said electrode surface.

14. A method for cleaning an ion source of a mass spectrometer for generating ions of a sample material, the ion source comprising an ionising light source arranged to output ionising light for ionising the sample material, and an electrode presenting an electrode surface for attracting the ionised sample material and upon which contaminant material is able to accumulate, the method including;
generating an ablating light beam or pulse(s) for ablating material of the electrode from the electrode surface, wherein the ablating light beam or pulse(s) does not include said ionising light;
reflecting, by a reflector, the ablating light beam or pulse(s) onto the electrode surface, therewith by a process of ablation removing a part of the electrode surface from the electrode together with said contaminant material when accumulated upon that part.

15. The method according to claim 14 in which the optical frequency of the ionising light is not less than a first threshold frequency, and the optical frequency of the ablating light beam or pulse(s) is not greater than a second threshold frequency, wherein the first threshold frequency exceeds the second threshold frequency.

16. The method according to claim 14 in which the ablating light beam or pulse(s) comprises visible light and/or infra-red (IR) light.

17. The method according to claim 14 in which the ionising light comprises ultraviolet (UV) light.

18. The method according to claim 14 comprising using the ionising light source for generating both the ionising light and the ablating light beam or pulse(s).

19. The method according to claim 14 including providing the light source for generating the ionising light with a non-linear optical medium, and therewith performing harmonic generation such that the ionising light is a harmonic of the light comprising the ablation light beam or pulse(s).
